(19) United States
(12) Patent Application Publication
(10) Pub. No.: US 2025/0285454 A1
(43) Pub. Date: Sep. 11, 2025

(54) SYSTEM AND METHOD FOR AUTOMATED 3D SEISMIC INTERPRETATION

(71) Applicant: Chevron U.S.A. Inc., San Ramon, CA (US)

(72) Inventors: Enning WANG, Bellaire, TX (US); Peter J. Lovely, Houston, TX (US); Lachlan Wright, Houston, TX (US); Sarah Vitel, Houston, TX (US); Anusha Sekar, Katy, TX (US)

(21) Appl. No.: 19/067,309

(22) Filed: Feb. 28, 2025

Related U.S. Application Data
(60) Provisional application No. 63/563,513, filed on Mar. 11, 2024.

(51) Int. Cl. G06V 20/64; G01V 1/30; G06V 10/26; G06V 10/30; G06V 10/774

(52) U.S. Cl. CPC G06V 20/64; G01V 1/30; G06V 10/26; G06V 10/30; G06V 10/774; G01V 2210/614

(57) ABSTRACT

A method is described for 3D seismic interpretation using a pre-trained 3D transformer that is fine-tuned for desired types of interpretation. It may be used with field seismic or synthetic seismic. The method is executed by a computer system.

### CROSS-REFERENCE TO RELATED APPLICATIONS

This application claims the benefit of U.S. Provisional Patent Application 63/563,513 titled “System And Method For Automated 3D Seismic Interpretation” filed Mar. 11, 2024.

### TECHNICAL FIELD

The disclosed embodiments relate generally to techniques for machine learning interpretation of 3D seismic images. In particular, the disclosed embodiments are of use for interpreting seismic faults and dense horizons as well as image denoising.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. The seismic images must be interpreted to identify structural and stratigraphic features of interest in order to delineate hydrocarbon reservoirs, avoid drilling hazards, plan well placement, and the like. Seismic interpretation conventionally requires a user to visually inspect a subset of lines in the seismic image to identify features such as seismic horizons that are then extrapolated throughout the volume. Some recent uses of machine-learning have automated this in a 2D manner. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for computationally efficient and accurate 3D interpretation of seismic images.

### SUMMARY

In accordance with some embodiments, a method of 3D seismic interpretation using a pre-trained transformer is disclosed. The method will receive at least one of field seismic data or synthetic seismic data as input data; pre-train a 3D transformer using the input data; and use a decoder to fine-tune the 3D transformer to perform segmentation, dense horizon interpretation, seismic denoising, or the like.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example system for 3D seismic interpretation;

FIG. 2 displays several views of a synthetic subsurface volume;

FIG. 3 demonstrates results of fault interpretations using embodiments of the system;

FIG. 4 demonstrates results of horizon stack interpretation using embodiments of the system; and

FIG. 5 demonstrates results of seismic denoising using embodiments of the system.

Like reference numerals refer to corresponding parts throughout the drawings.

### DETAILED DESCRIPTION OF EMBODIMENTS

Described below are methods, systems, and computer readable storage media that provide a manner of 3D seismic interpretation using machine learning. These embodiments are designed to be of particular use for post-stack image denoising, fault interpretation, and horizon stack (dense horizon, relative geologic time) prediction.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The advances in neural network architecture and graphics processing unit (GPU) computational capability have aided in tasks such as image classification, transformation, and segmentation, etc. Since the default implementations of these techniques in Computer Vision (CV) are mostly in 2D, lift and shift to 3D seismic data without semantic reasoning of 3D topology may cause discontinuity in the 3rd dimension. For 3D neural networks, hardware (GPU) memory limits the size of a sub-volume that a neural network can process at a given time. It is challenging for a neural network to extract features or objects which exceed the size of the chosen sub-volume.

Large foundation models trained on data at scale can learn the underlying data representations and have been demonstrated to have superior generalization when fine-tuned to perform downstream tasks in various domains including language/speech processing, and various Computer Vision (CV) tasks as well as multi-modality data integration. Compared to the domain of Computer Vision and language modeling, the adoption of pre-trained 3D foundation models for seismic processing and interpretation has been slow. Part of the reason is that most of the modern state-of-the-art CV models does not solely rely on architectural advancements alone but have been benefiting from large-scale, extended pre-training. In contrary to large public natural image databases such as ImageNet, there has been a lack of similar scale, geologically- and geophysically-diverse, and publicly available, field seismic databases in 3D post-stack domain for model pre-training. In addition, the fast-evolving imaging and velocity modeling algorithms in the past decades have left many existing public datasets obsolete, with potential generalization degradation to the latest acquisition and images due to data domain gaps.

Compared to training an ML model from scratch, there is significant uplift to pre-train on a large and relevant pre-training set and then fine tune on a smaller dataset for special use cases. The uplift lies on both the model's generalization capability and the down-stream prediction accuracy. Compared to supervised pre-training, which requires labeled data, self-supervised pre-training is more appealing with no need for labeled data and higher fine-tuning prediction accuracy than supervised pre-training. For seismic interpretation, pre-training the 3D Swin Transformer on large amount of field seismic data allows the model to learn 3D semantics of field images and alleviate the burden to rely on labeled synthetic data or limited amount of field data to train the feature extractor.

To explore the effects of pre-training on 3D seismic problems, we built a global database of 3D post-stack field seismic images from various surveys acquired with various acquisition technologies and geometry both onshore and offshore. The database is unlabeled, which can either be used for un-supervised pre-training or serve as clean labels for denoising autoencoders. In an embodiment, a simple, depth-dependent data selection is performed, which keeps the high-quality data areas below water bottoms and above ˜15 k meters. Water layers and noisy areas below 15,000 meters may be used to build as a noise-only database for synthetic data augmentation and feature engineering of denoising tasks.

A 3D Swin Transformer was pre-trained and then coupled with an appropriate decoder to be fine-tuned on both augmented field and labeled synthetic data for three processing and interpretation tasks: image denoising, fault detection and seismic horizon stack/RGT prediction. We compare the results from pre-trained Transformers with convolutional models to examine the difference in performance brought by both the Transformer architecture and the pre-training. An embodiment may use one of the self-supervised reconstructive pre-training algorithms—SimMIM (Xie, et. al., 2022) to train a Transformer encoder with a lightweight densely connected decoder. The original 2D algorithm has been adapted to 3D masked image modeling. The 3D seismic training samples with size of 2563 are further divided into smaller 3D tiles of 323. In an embodiment, during pre-training, ˜60% of the tiles are masked and the model takes the unmasked inputs to predict the masked areas. The Transformer encoder was pre-trained using distributed TensorFlow (Abadi, et. al., 2015) on one machine with 8 A100 GPUs for 100 epochs. After pre-training, the method may discard the light-weight decoder and connect the Transformer with an Atrous Spatial Pyramid Pooling (ASPP) decoder from DeepLab v3+ (LC Chen, et. al., in 2018) for fine tuning, to extract multi-scale features in the latent space for extracting multi-scale context.

One challenging use case for Deep Learning models are the deep intervals of seismic data where both signal and noise are stretched and over-sampled, causing networks trained on clean and high-resolution sediment images such as synthetic data to underperform. There are noticeable performance improvements using pre-trained Transformer models on field data over convolutional models trained purely on synthetics.

The methods and systems of the present disclosure may, in part, use one or more models that are machine-learning algorithms. These models may be supervised or unsupervised. Supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Unsupervised learning algorithms are trained using unlabeled data, meaning that training data pairs are not needed. By way of example and not limitation, unsupervised learning algorithms may include clustering and/or association algorithms such as k-means clustering, principal component analysis, singular value decomposition, etc. Although the present disclosure may name specific models, those of skill in the art will appreciate that any model that may accomplish the goal may be used.

In this work we implemented a series of innovative improvements in both the forward fault modeling algorithm for generating synthetic seismic and fault labels, the Neural Network architecture for fault segmentation, and the training workflow to leverage self-supervised pre-training. These changes allow for improved model performance on the most challenging field seismic datasets. The main contributions of this paper include:
The feasibility of extending a 2D Swin Transformer to 3D and applying to 3D seismic.
Pre-training the same 3D Transformer and fine tuning on various tasks including dense prediction and image segmentation.
Improved synthetic data with realistic field geology features.
Post prediction global inversion for dense horizon subcube merging.

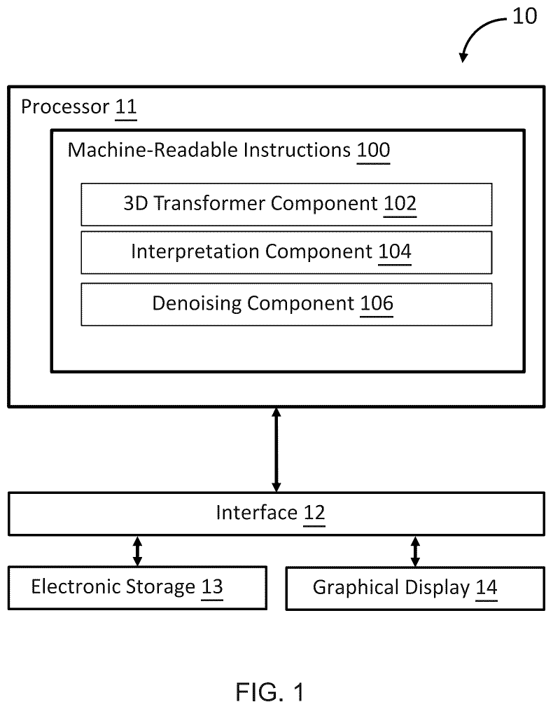

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 14, and/or other components. The system 10 receives 3D seismic images and produces interpretations and/or denoised images from the 3D seismic images.

The electronic storage 13 may be configured to include any electronic storage medium that electronically stores information. The electronic storage 13 may store software algorithms, information determined by the processor 11, information received remotely, and/or other information that enables the system 10 to function properly. For example, the electronic storage 13 may store information relating to input 3D seismic images, synthetic subsurface models, and/or other information. For example, the electronic storage 13 may store information relating to output interpretations, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to fault interpretations, denoised images, dense horizon interpretations, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate 3D seismic interpretation and/or denoising. The machine-readable instructions 100 may include one or more computer program components. The machine-readable instructions 100 may include a 3D transformer component 102, an interpretation component 104, a denoising component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the 3D transformer component 102 may be configured to train a 3D transformer such as a 3D Swin Transformer. It may also be configured to receive a pre-trained 3D transformer to be used by the other components in the system. In an embodiment where the 3D transformer component 102 is training the 3D transformer, it may use field seismic data and/or synthetic seismic data. By way of example and not limitation, this embodiment may perform the following method:

### Model Architecture & Unlabeled Field Seismic Database

We built a proprietary 3D field seismic database in post-stack domain, which consists of post-stack 3D seismic from 62 field surveys worldwide, acquired with various acquisition technologies and geometry both onshore and offshore. The database is unlabeled, which can either be used for un-supervised pre-training or serve as clean labels for denoising autoencoders. A simple, depth-dependent data selection is performed, which separated water layers and noisy areas below 15,000 meters as a noise-only database for synthetic data augmentation and feature engineering of denoising tasks. A database of similar or larger scale can also be constructed from publicly available seismic surveys, as recently claimed in the study of H. Sheng, et. al., 2023.

The size of the database is about IT on disk. When cropped to training sample size of 256×256×256, the total number of 3D training samples equals to about 15,000. Weak augmentation such as horizontal flipping and 90-degree rotations can boost the number up to 120,000 subcubes. Since the size of the pre-training database is still smaller than the ImageNet-1k database we expect further improved fine-tuning performance from field data pre-training on even larger field database.

A Swin Transformer v2 model (Liu, et. al., 2022) was pre-trained to learn a general representation of 3D field seismic images. We used one of the reconstructive pre-training algorithms—simMIM (Xie, et. al., 2022) to train the Transformer encoder for 100 epochs using a lightweight densely connected decoder, an L1 loss, a 32³-mask size and 60% masking ratio. The model was trained using distributed TensorFlow (Abadi, et. al., 2015) on one machine with 8 A100 GPUs each with 80 Gb of memory. Pre-training the 3D Swin Transformer on large amount of field seismic data allows the model to learn semantics of 3D field images and alleviate the burden to purely rely on labeled synthetic data or limited amount of field data to train the feature extractor.

Unlike the promotable Segment Anything Model by A. Kirillov, et. al., the goal in this work is to fine tune the same pre-trained Transformer as a foundation model for various tasks including seismic denoising and interpretation such as fault or horizon (RGT) interpretation. To train task-specific the fault/RGT prediction models, the pre-trained Transformer encoder was fine-tuned on labeled synthetic seismic and fault/RGT pairs. We generally fine tune the model on 6-10 k synthetic samples for about 50 epochs. For seismic image denoising, we randomly draw noise samples from the noise database to be scaled and added to the clean seismic signals as training features to tune the Transformer.

### Synthetic Seismic Modeling

Certain dense seismic labels such as fault probability or Relative Geological Time (RGT) can be too cumbersome to manually create on field data. Compared to manually labeled field data, synthetic training data is less expensive and has more consistent and complete labels. The limitation of synthetic training data is the lack of realistic geological features including water bottom, salt bodies, unconformities, and complex fault systems, etc. Other field seismic features such as fault plane reflections, across-fault amplitude contrast, and any acquisition footprint or migration artifacts such as vertical amplitude striping, swing noise, multiples, illumination variations, and depth-varying wavelet stretching are also not present in synthetic seismic.

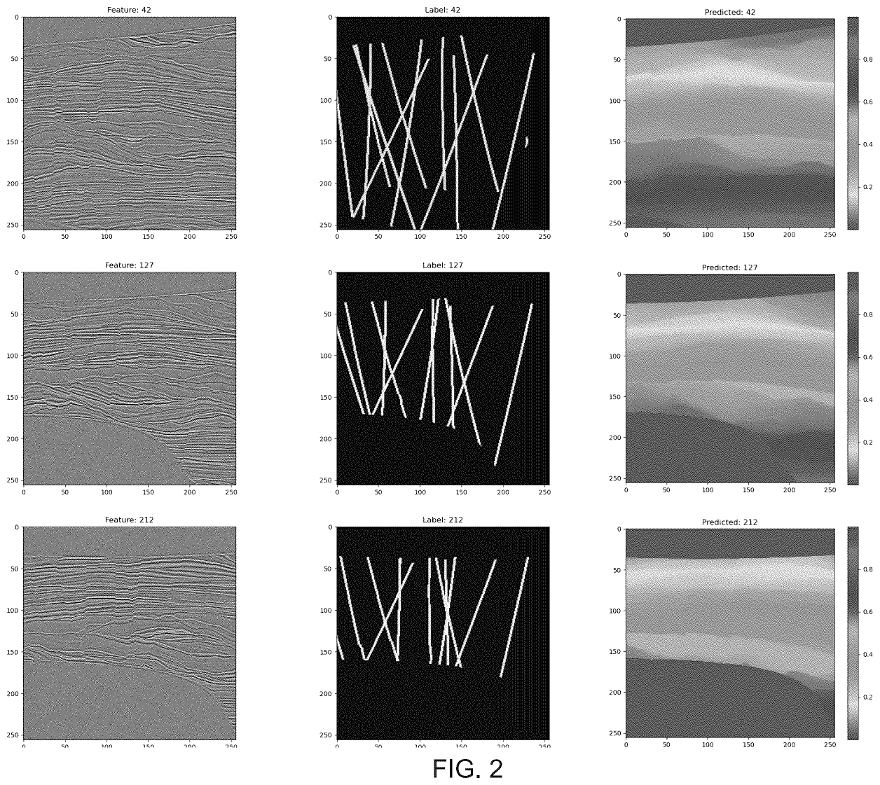

To partially overcome the lack of geological features in synthetic training data, we built simple unconformities using a sequence of folded acoustic impedance models, concatenated in depth with overlapping regions in between. The stratigraphy subsections are merged vertically along randomly generated near-horizontal, parabolic surfaces within the overlap zones. The sequence of folded acoustic impedance also enables adding a simple water layer by removing internal reflectivity in the top layer post-faulting. A salt body can also be added in the post-faulting stage to avoid generating faults within the water layer or salt bodies. In FIG. 2 we show one example of a 3D synthetic model with water, unconformities, salt, and faults. During training, synthetic seismic was augmented using realistic migration noise.

The synthetic faults were modeled using geological priors of individual fault attributes and the spatial geometry of a fault network. When adding a new fault to a synthetic model, we first choose a fault type from one of the three categories: Normal, thrust and strikes-slip faults, with 70%, 10% and 20% probability, respectively. Based on field observations, dip angles of fault planes (measured from vertical down) were drawn from uniform distributions of 40°-75° for normal faults, 15°-40° for thrust faults, and 75°-90° for strike-slip faults, measured from horizontal. The normal and thrust faults shear in the up dip and down dip directions and transform faults only in the horizontal direction along the fault strike. The slip distribution on a fault plane follows a Gaussian distribution within the ranges defined by pre-selected fault radius. Fault label volumes were created by thresholding the absolute differential displacement field across the fault plane in the dip normal direction.

Fault network spatial geometry was optimized based on two field observations: 1. neighboring faults are separated by certain distance: Stress shadow zones for existing faults in a fault model were enforced to effectively prevent new faults from nucleating within a certain distance. When adding new faults, the minimum distance from all existing faults must be higher than a set threshold. 2. Faults usually form in parallel groups. When proposing a new normal fault, there is certain chance that a group of near parallel faults are added to the model at the same time. And 3. Intersecting faults form small angles. When adding a new fault, from a list of potential fault azimuth and dip angle combinations, the one that forms the smallest angle with all existing faults is selected to avoid having 90° crossing faults. Another potential uplift on spatial geometry is to parameterize fault geometry on a larger cube and sample the interior to remove boundary effects, or alternatively using a fault network extracted from field data.

The dense horizon (also called relative geologic time RGT) volumes in the third column were vertically merged using normalized indices of the acoustic impedance layers within individual subsections. During subsection merging, a small increment 0.1 was added to the deeper subsection to represent the gap in geological time between neighboring continuous sections of sediments. In the later fault creation stage, the same fault displacements on seismic and fault label volumes were applied to the RGT volumes to be consistent among the three. In the last step, the RGT values within water and salt were fixed at the minimum and maximum values of the entire volume, and fault labels within water and salt bodies were removed.

Besides synthetic fault attributes and geometry, we augment synthetic seismic using elastic deformation and field noise. During training, the samples are augmented by random flipping, horizontal rotation, and polarity reversal to increase diversity. In addition to the scale limitation of 3D models for large objects including faults, lower signal to noise ratio (S/N), illumination shadow, and loss of resolution in the deep intervals or subsalt areas of field images also caused gaps with synthetic training data and potentially lower model performance.

The interpretation component 104 may be configured to perform fault interpretations, seismic horizon interpretations, and/or horizon stack/dense horizon/relative geologic time (RGT) interpretations.

Fault interpretation is a critical input for building reservoir models, mitigating drilling and production hazards and understanding reservoir connectivity. Since the work of Wu, et. al., 2019, predicting fault probability from 3D seismic using Deep Learning based image segmentation has been widely studied and applied throughout the industry to speed up manual picking and improve interpretation quality and consistency. Despite the success of generic 3D U-Net trained on synthetic data in shallow sediments where signal to noise ratio and frequency band width are high, applying the technology to field seismic data at reservoir depth or even subsalt poses generalization challenges due to the divergence in scale, fault geometry, slip direction, resolution and noise levels between training and prediction data. Unique features in field data such as coherent noise, illumination shadow, lack of high-resolution displacements, and spatially varying scale further complicate the problem. We resolve these issues by changing the model architecture from a classic 3D U-Net to a Swin Transformer encoder, a multi-scale feature extractor. The 3D subcube size has also been increased to broaden the field of view for superior fault resolution and continuity.

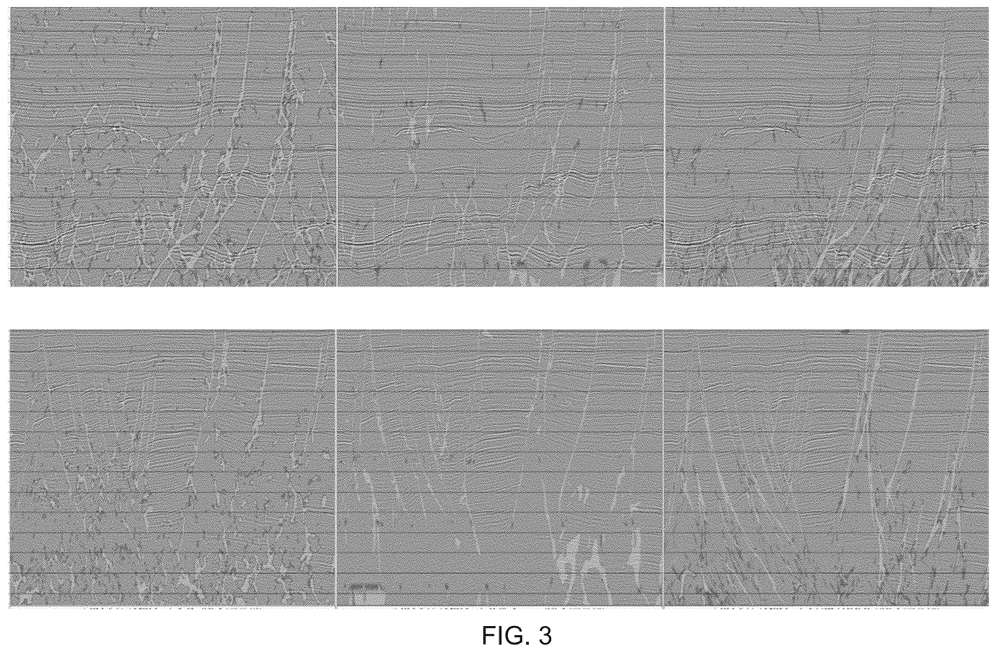

Following the work of Ronneberger et al., 2015 and Wu, et. al., 2019, we first start from a 3D U-Net architecture for seismic fault interpretation. The training workflow was designed to train a general 3D fault detection model on labeled synthetic data, and optionally fine tune on manually labeled field data. No re-training is required for new seismic surveys. We observed that while the original 3D U-Net model trained on 128³ cubes interprets major faults, it also results in noisy and fragmented faults on field data, and the model performance typically decreases with depth (left panels in FIG. 3).

To improve the performance in the deep sections of images where S/N gets lower, wavelets are stretched, and the scale of structures increases, we increased 3D training sample size from the original 128³ to 256³ for bigger field of view. In addition, we adopted an Atrous Spatial Pyramid Pooling (ASPP) decoder from the DeepLab V3+ work conducted by LC Chen, et. al., in 2018, to effectively extract multi-scale features in the latent space for better continuity in the deep section. Compared to the generic U-Net, the DeepLab V3+ fault probabilities have become cleaner and more continuous. As discussed in the architecture section, we also developed the more recent 3D Swin Transformer Encoder pre-trained on field data as an effective feature extractor to replace the encoder part of the DeepLab V3+ model. The Transformer results (the third panels of FIG. 3) show cleaner, more continuous fault networks, with higher horizontal fault plane definition in densely distributed fault systems. The Transformer results also remain robust in the deep sections when results of the other two models started to degrade. When test data differ significantly from the synthetic fine-tuning data, such as the subsalt Gulf of Mexico environment, the Transformer results show higher sensitivity to low-throw normal faults, with overall geologically more sensible fault geometry at reservoir depths over 30 k ft depths.

During inference, resampling the input seismic can be used to mitigate the degradation caused by scale difference between training and prediction data. In the shallow sediments, horizontal up-sampling and edge enhancement help pick dense parallel faults and reduce fault thickness. In the deep section where data are usually over sampled, vertical down sampling may improve the fault continuity in the vertical direction. Low-quality seismic can be preprocessed by sharpening or denoising to reduce noise-induced false positives. No post-processing is applied to the probability results shown in FIG. 3. During the Transformer inference the subcube overlap percentage has been increased to be over 80 percent to increase robustness of the results and create a spatially varying probability in a similar way to bootstrap uncertainty estimation.

Multi- or dense horizon interpretation can help understand fault trends, sediment transport, identify fairways and channels as inputs to structural and reservoir modeling, as well as dynamic simulation. Different from single horizon propagators/trackers, dense horizon interpretation can leverage more information in a larger window to better interpret complex discontinuities like salt, faults, and unconformities, etc, to reduce the needs for discontinuity constraints or heavy manual editing to correct for misinterpretations. In recent years, long-offset OBN acquisition, Full Waveform Inversion (FWI) and Least Square Migration (LSM) have brought step changes in image quality both in terms of S/N and illumination that makes auto multi-horizon stack (RGT) estimation feasible. In 2021, Z. Bi et. al., trained 3D models to predict RGT from seismic using synthetic seismic—RGT pairs, without explicit boundary constraints like salt, faults, or stratigraphic horizons.

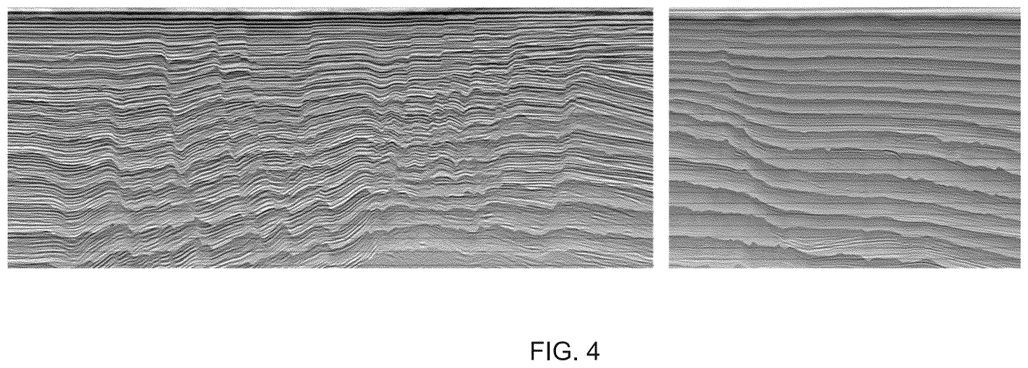

In this work we fine tune the same pre-trained Transformer on paired synthetic seismic-RGT training data shown in FIG. 4 for a model that predicts RGT from seismic. The sigmoid activation in the decoder of the model was removed and an L1 loss was replaced by a multi-scale structural similarity (SSIM) loss (Wang, et. al., 2003) to capture the structural complexities of the predicted RGT volumes. Since each of the RGT subcube is only predicted locally independent of neighboring subcubes, a direct weighted merge can introduce strong checkerboard artifacts. To create a smooth transition across subcube edges and add a global baseline during merging, we assign a scalar and a bias to each subcube and use ‘L-BFGS-B’ algorithm to invert for optimal values of the scalar and bias terms by minimizing the L2 norm of overlap differences among all neighboring subcubes. The global inversion is effective in merging local RGT predictions into a global one. The prediction results on two public datasets Opunake and Parihaka are displayed using a discrete colormap and overlaid on seismic below, which follows the main structural orientation but may deviate from the exact horizons locally.

The denoising component 106 may be configured to reduce noise in the 3D seismic image. Besides image segmentation tasks such as fault detection, the same pre-trained Transformer model can also be tuned to dense prediction including seismic denoising, super resolution or seismic to RGT mapping. Following the idea of auto-encoder training, we fine tune the pre-trained 3D Transformer using noised field seismic data for seismic noise attenuation.

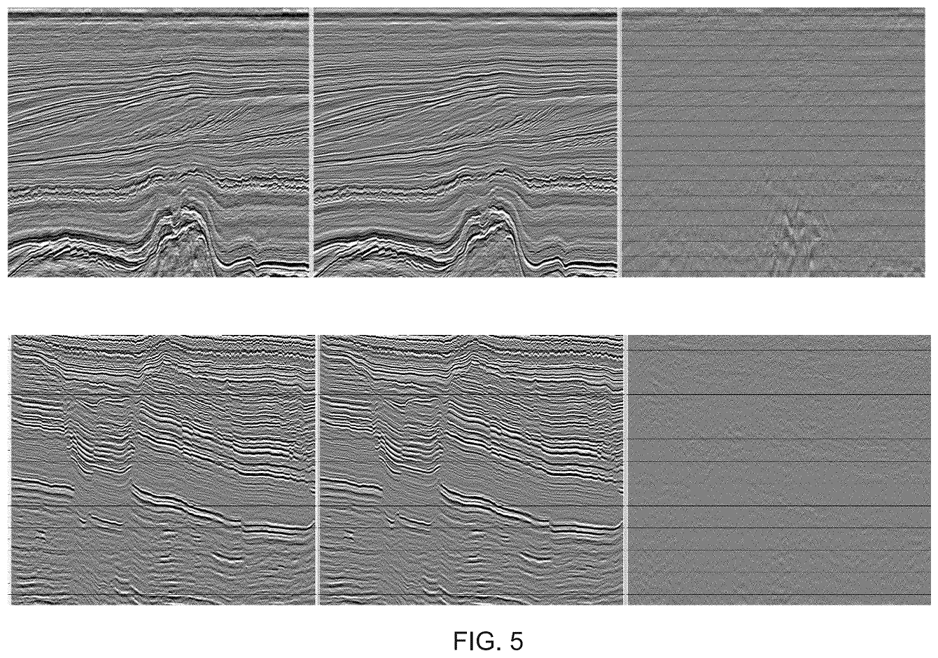

The unlabeled field seismic samples for pre-training are used as the clean labels for seismic image denoising. To introduce noise to clean labels and generate training features, we built a noise-only database from field noise in water layers and the deep sections of an image. Noise samples are randomly sampled from the noise-only dataset and are scaled and added to the clean labels. These clean labels are then paired with the noise-contaminated versions of themselves as training samples. In the training input pipeline, the clean signal samples are randomly merged with scaled (0.5-1.0) noise samples with different noise-to-signal ratios to train models with different aggressiveness on noise attenuation. In FIG. 5 we observed that the Transformer model can attenuate undesirable acquisition and imaging artifacts, with very limited signal leakage.

Compared to the original U-Net and the DeepLab v3+ models, the 3D Swin Transformer predicts geologically more realistic, including parallel or conjugate fault systems that are similar to those in the realistic synthetic fault training data. The Transformer results also exhibit superior performance on low angle, low throw, listric faults, densely distributed “bookcase” faults, and strike-slip faults which are often missed by the other two models. The geologically realistic dip angles in the synthetic training data helped reduce vertical false positives compared to predictions from models trained on predominantly vertical synthetic faults. Existence of transform faults in the training data improves the detectability of faults with predominantly strike-slip components. Fault continuity and signal-to-noise ratio have been improved for easier fault extraction, editing, and modeling. The improvements in the deep sections are critical for assessing reservoir quality and reducing development risks. The Transformer has been tested and shown effective on both conventional Migration® and FWI images, as well as in multiple geological environments: Conventional/unconventional reservoirs, shallow hazard, and subsalt, etc.

The same training and prediction algorithm can be extended to other features in seismic such as horizons, stratigraphic boundaries, channels, salt, and other geobodies. The modification includes labeling the corresponding features of interest in the synthetic seismic during generation and updating the Machine Learning model from binary to multi-class classification. Stratigraphic boundaries, for example, can be labeled as the boundaries between two consecutive stratigraphic sequences and framed as a similar binary classification problem.

In prediction stage, running inference on an entire 3D seismic volume with thousands of pixels in each of the three dimensions cannot be accommodated by a single GPU. Instead, the entire volume is cropped into overlapped subcubes to run inference independently before being weighted by a 3D Gaussian function and stitched back together. We observed that due to changes in context, sliding a subcube by a small percentage of its length results in a different prediction result. We took advantage of the shift variance nature and use repetitive, dense input data sampling to aggregate binary fault indicators in overlapping zones to create meaningful fault “probability”, reflecting uncertainty in fault existence/continuity due to input and background context changes. For example, each pixel gets weighted contribution from 103 independent predictions with 90% overlap percentage. The results using dense input sampling tend to be more continuous and robust in noisy areas and shows a gradation towards fault truncation. The cost associated with high overlap percentage is much higher than regular inference, while the “probability” still lacking uncertainty of model bias.

The Future research in this area may include predicting fault throw and extracting individual faults in detection stage. Training the fault detection network in a surface-aware manner with topological/geological constraints can potentially regulate and reduce noise and minimize false positives. An end-to-end detection, extraction, and surface modeling training method by combining instance segmentation and Convolutional Occupancy Networks developed by Peng et. al., in 2020 can further automate the current cascaded workflow.

The same pre-trained Transformer model can be fine-tuned as an auto encoder for post-stack seismic image noise attenuation. We showed that the denoising model can successfully attenuate random and swing noise while preserving the signal amplitudes, making it an ideal tool for amplitude-sensitive seismic inversions. Compared to denoising and fault detection, estimating relative geologic time (RGT) directly from seismic is more challenging due to the higher requirements on input data quality and similar training and test data distributions. The non-unique nature of RGT volumes with geologically complex discontinuities such as unconformities and salt boundaries further challenge unconstrained direct RGT prediction. The results show that while the large-scale conformity could be achieved, there may still be room for quality improvements using training data more like field data, alternative losses other than SSIM that can better capture structural conformity, and fine scale snapping in post-processing. Input data quality also plays an important role, we noted that compared to old public seismic, RGT prediction quality is higher using modern imaging products such as FWI pseudo-reflectivity.

In summary, we have demonstrated that subsurface data processing and interpretation can benefit from prior geological and geophysical knowledge learned from large-scale pre-training, as well as the latest advances in the AI/ML architectures. There are remaining issues with the presence of salt and deep, subsalt low quality seismic. Further performance gain may be achieved from even larger pre-training set, or semi-supervised learning that leverages challenging field data (subsalt, etc.) to improve the robustness of models in noisy areas with stretched wavelet, poor illumination, and other types of artifacts.

Besides fault and dense horizon interpretation, the 3D foundation model can be fine-tuned for other down-stream tasks with corresponding labels. Including but not limited to: Interpreting seismic facies, salt bodies, drilling hazards, high-pressure zones, direct hydrocarbon indicators, structural traps, seals, CO2 plumes, etc. In the area of image-to-image translation, besides denoising, the model can also be tuned to for image frequency bandwidth extension (e.g., super-resolution), or being applied to seismic inversion to derive acoustic and elastic properties.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The present invention relates to a system that incorporates novel machine learning architectures for 3D seismic interpretation and denoising, including image segmentation, fault interpretation, and dense horizon prediction. These architectures, which surpass human mental processes, operate beyond predefined algorithms and adapt dynamically to input data. In particular, the system leverages deep learning models, neural networks, and other advanced techniques to achieve unprecedented performance.

Machine learning has revolutionized various fields by enabling computers to learn from data and make informed decisions. Traditional algorithms, while effective, often rely on fixed rules and predefined routines. In contrast, the proposed system harnesses the power of machine learning architectures that transcend these limitations.

The adaptive, dynamic nature and utilization of advanced architectures redefine the boundaries of computational capabilities. By design, machine learning architectures function outside of any preprogrammed routines. Thus, the training and/or analysis performed by machine learning architectures is not performed by predefined computer algorithms but rather improve the functioning of the computer system and extends well beyond mental processes and abstract ideas.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for training a 3D transformer for 3D seismic interpretation, comprising:
one or more processors;
memory; and
one or more programs, wherein the one or more programs are stored in the memory and configured to be executed by the one or more processors, the one or more programs including instructions that when executed by the one or more processors cause the system to:
a. receive at least one of field seismic data or synthetic seismic data as input data;
b. pre-train a 3D transformer using the input data; and
c. use a decoder to fine-tune the 3D transformer on labeled seismic data to perform at least one of segmentation, dense horizon interpretation, and seismic denoising.

2. The system of claim 1 further comprising instructions that when executed by the one or more processors cause the system to receive a target 3D seismic image and use the 3D transformer to perform image segmentation on the target 3D seismic image.

3. The system of claim 1 further comprising instructions that when executed by the one or more processors cause the system to receive a target 3D seismic image and use the 3D transformer to perform dense horizon interpretation on the target 3D seismic image.

4. The system of claim 1 further comprising instructions that when executed by the one or more processors cause the system to receive a target 3D seismic image and use the 3D transformer to perform seismic denoising on the target 3D seismic image.

5. The system of claim 1 wherein the 3D transformer is a 3D Swin transformer.

6. The system of claim 1 wherein the synthetic seismic data is generated from a synthetic 3D earth model and has migration noise added.
